(19) United States
(12) Patent Application Publication
(10) Pub. No.: US 2018/0339433 A1
(43) Pub. Date: Nov. 29, 2018

(54) SECURITY LABEL AND MANUFACTURING METHOD OF THE SAME

(71) Applicants: CHENG-HSIANG LIN, Changhua (TW); DIAN-WEI CHEN, Changhua (TW)

(72) Inventors: CHENG-HSIANG LIN, Changhua (TW); DIAN-WEI CHEN, Changhua (TW)

(73) Assignee: JUN HE TECHNOLOGY CO., LTD., CHANGHUA (TW)

(21) Appl. No.: 15/604,289

(22) Filed: May 24, 2017

(51) Int. Cl. B29C 33/42; B29C 45/26; G06K 1/12

(52) U.S. Cl. CPC B29C 33/428; B29L 2017/00; G06K 1/126; B29C 45/263

(57) ABSTRACT

A plastic injection security label and manufacturing method of the same may comprise a mold having a pair of die sets, and at least one of the two die sets has a molding cavity formed on an inner surface thereof. The surface of the molding cavity has a plurality of nicks formed by the laser engraving machine at partial positions thereof, and the engraved nicks are arranged into a designed image or code to form a label generating area on the surface of the molding cavity. In the manufacturing process, after the die sets are coupled together, the plastic material is injected into the mold and filled with the molding cavity and the nicks of the label generating area, and a plastic product with the security label is integrally formed after the plastic material is cooled and solidified.

### FIELD OF THE INVENTION

The present invention relates to a security label, and more particularly to a plastic injection security label and manufacturing method of the same to providing a comprehensive anti-counterfeiting effect.

### BACKGROUND OF THE INVENTION

Laser label, QR label and QR code are widely manufactured in form of a stick or tag attached to the surface of a product to realize the anti-counterfeiting effect, and with the sticker, the customer can identify the authenticity of the product from an image or a code printed on the sticker. The anti-counterfeiting sticker can not only protect the rights and interests of manufacturer but also prevent customers from buying an inferior product. Moreover, the manufacturer can use the sticker to provide the information of product including country of origin, manufacturer info, product name and manufacturing date to customers.

However, the conventional anti-counterfeiting sticker is disadvantageous because: (i) The laser and QR code stickers are easy to be torn from the package of product by intentional person, and other kinds of stickers which can be easily attached on the package has its shortcoming in poor identification; (ii) it still needs to waste labors to attach the anti-counterfeiting sticker to the package of product after manufacturing, which increases the costs; (iii) the manufacturer has to manufacture the sticker of product additionally; and (iv) the sticker is always attached to the package or cover of product, which cannot protect the interior components or parts of the product. Therefore, there remains a need for a new and improved design for a plastic injection security label and manufacturing method of the same to overcome the problems presented above.

### SUMMARY OF THE INVENTION

The present invention provides a plastic injection security label and manufacturing method of the same which can manufacture a security label integrally on a plastic product. The present invention comprises a mold having a pair of die sets, and at least one of the two die sets has a molding cavity formed on an inner surface thereof. The surface of the molding cavity has a plurality of nicks formed by the laser engraving machine at partial positions thereof, such that the nicks are at positions lower than the surface of the molding cavity. The engraved nicks are arranged into a designed image or code to form a label generating area on the surface of the molding cavity. In the manufacturing process, after the die sets are coupled together, the plastic material is injected into the mold and filled with the molding cavity and the nicks of the label generating area, and a plastic product with the security label is integrally formed after the plastic material is cooled and solidified. Moreover, the plastic product and the security label are formed integrally from the mold, and the manufacturer can design the label generating area to generate a designated security label on the plastic product, thereby achieving the anti-counterfeiting effect.

Comparing with conventional anti-counterfeiting label, the present invention can provide better anti-counterfeiting effect because: (i) the security label is integrally formed with the plastic product, which not only prevents the security label from been torn by intentional person but also saves costs and labors; and (ii) the plastic product can be an inner part or component of a commodity, which provides a comprehensive anti-counterfeit effect.

### BRIEF DESCRIPTION OF THE DRAWINGS

FIG. 1 is a three-dimensional view of a mold of the present invention used for manufacturing a plastic product with a laser security label.

FIG. 2 is a partial enlarged view of a die set of the present invention which has a molding cavity.

FIG. 3 is a plan view illustrating a pair of die sets of the present invention are coupled together and the plastic material is filled with the molding cavity.

FIG. 4 is a plan view illustrating the pair of die sets of the present invention are detached from each other and the plastic product with the laser security label is manufactured.

FIG. 5 is a three-dimensional view illustrating the plastic product is integrally formed with the laser security label (using a mobile phone case as an example).

FIG. 6 is a top view of FIG. 5.

FIG. 7 is a partial enlarged view of FIG. 6.

FIG. 8 is a three-dimensional view of the mold of the present invention used for manufacturing the plastic product with a QR code security label.

FIG. 9 is a partial enlarged view of FIG. 8.

FIG. 10 is a plan view illustrating the plastic product is integrally formed with the QR code security label (using a mobile phone case as an example).

FIG. 11 is a three-dimensional view of FIG. 10.

FIG. 12 is a partial enlarged view of FIG. 11.

FIG. 13 is a three-dimensional view of the mold of the present invention used for manufacturing the plastic product with a barcode security label.

FIG. 14 is a partial enlarged view of FIG. 13.

FIG. 15 is a plan view illustrating the plastic product is integrally formed with the barcode security label (using a mobile phone case as an example).

FIG. 16 is a three-dimensional view of FIG. 15.

FIG. 17 is a partial enlarged view of FIG. 16.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

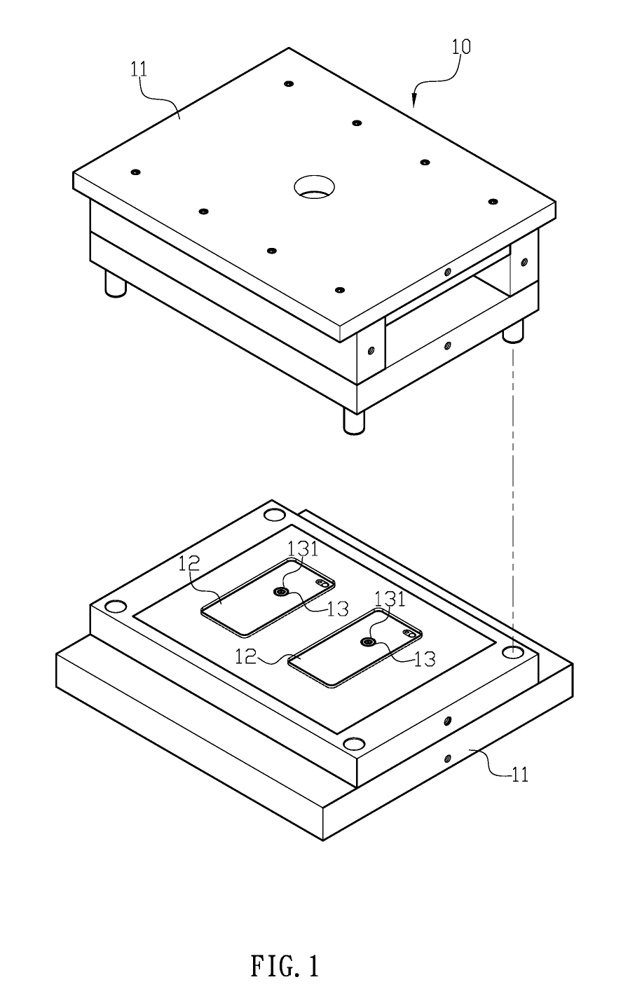

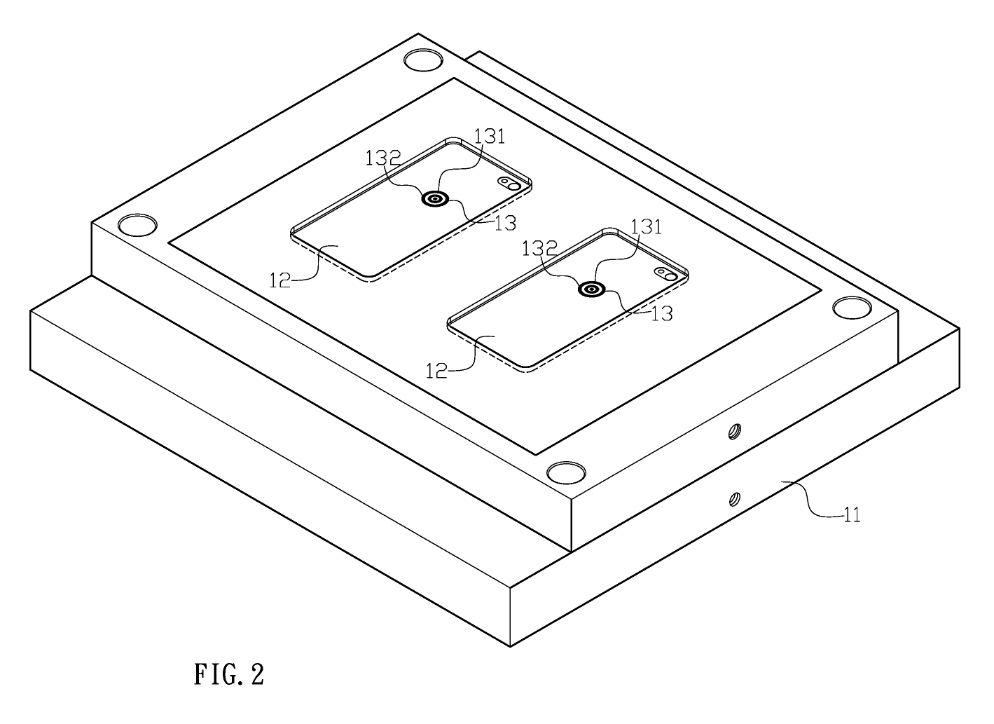

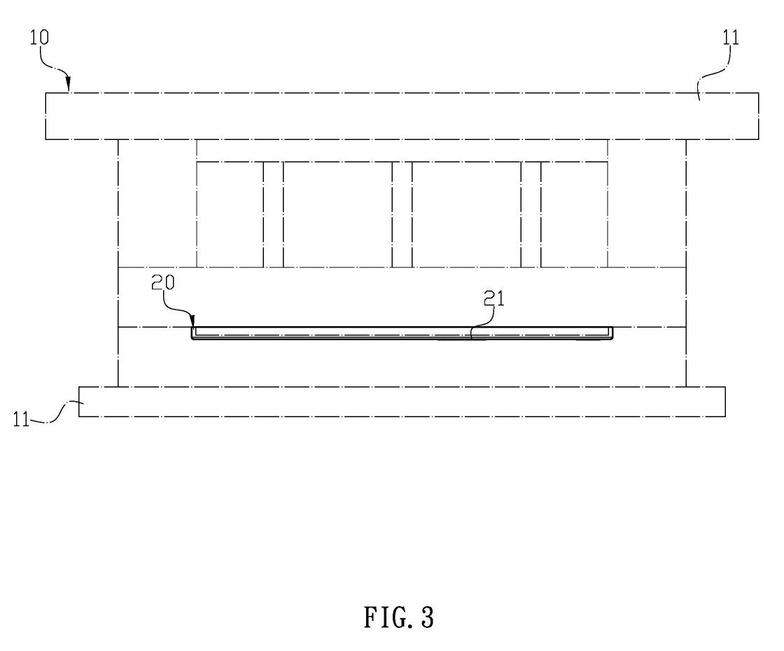

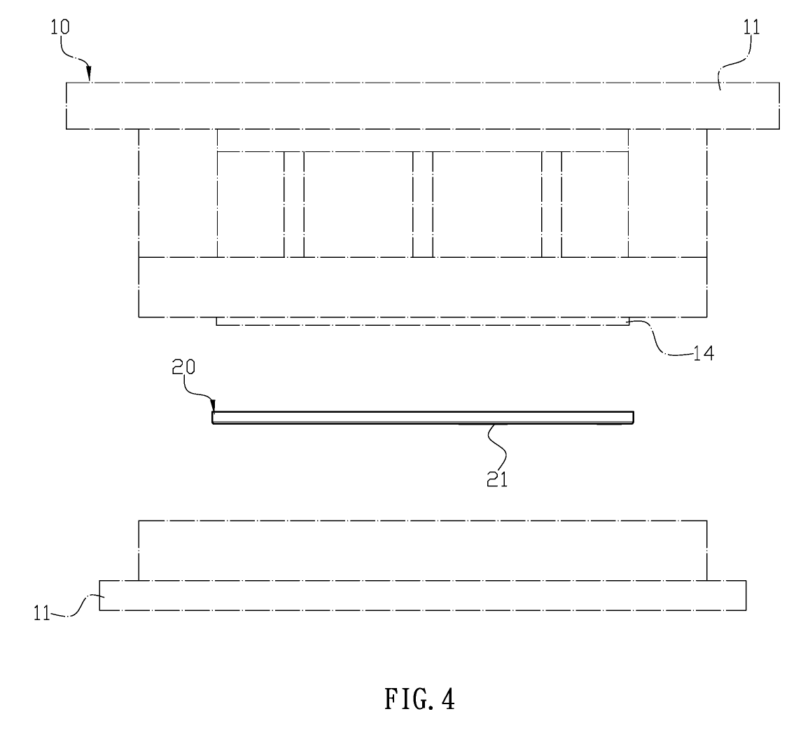

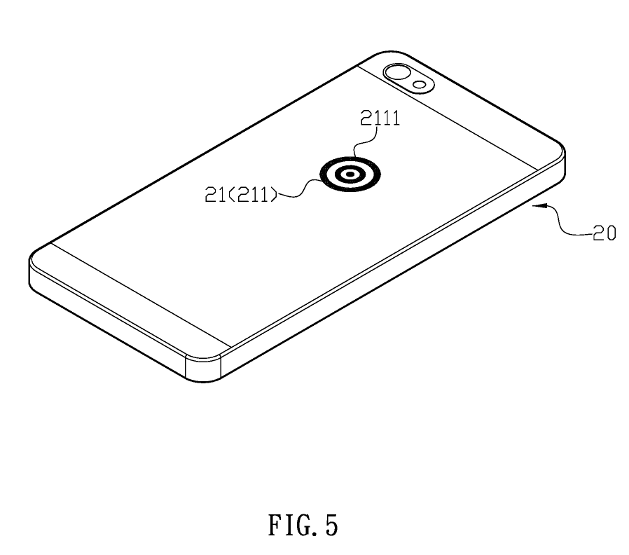

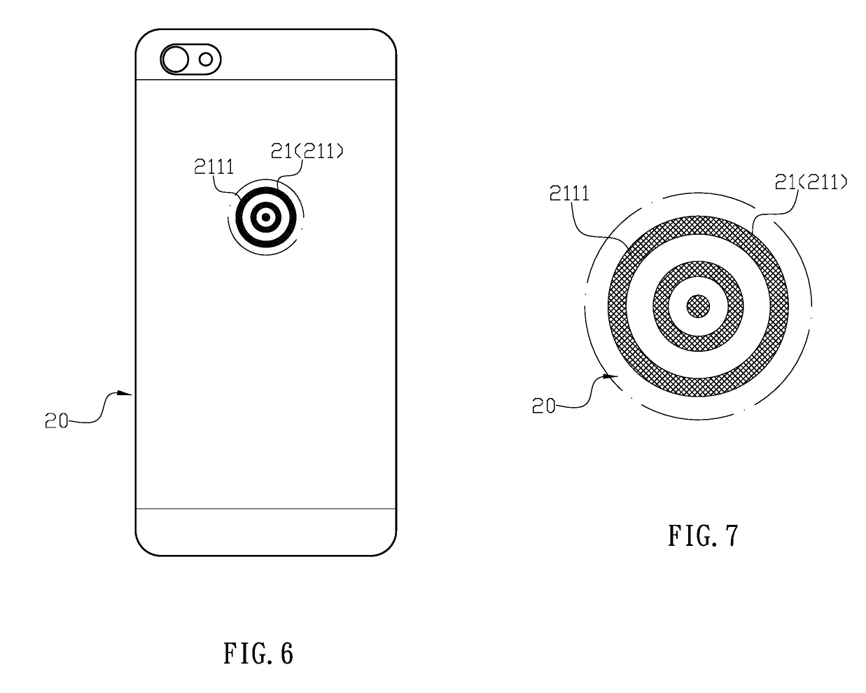

Referring to FIGS. 1 and 2, the present invention provides a plastic injection security label and manufacturing method of the same which can manufacture a security label (21) integrally on a plastic product. The present invention comprises a mold (10) having a pair of die sets (11), and at least one of the two die sets (11) has a molding cavity (12) formed on an inner surface thereof. The surface of the molding cavity (12) has a plurality of nicks (131) formed by the laser engraving machine at partial positions thereof, such that the nicks (131) are at positions lower than the surface of the molding cavity (12). The engraved nicks (131) are arranged into a designed image or code to form a label generating area (13) on the surface of the molding cavity (12). In the manufacturing process, after the die sets (11) are coupled together, the plastic material is injected into the mold (10) and filled with the molding cavity (12) and the nicks (131) of the label generating area (13), and a plastic product (20) with the security label (21) is integrally formed after the plastic material is cooled and solidified (as shown in FIGS. 3 and 4). Moreover, referring to FIGS. 5 to 7, the plastic product (20) and the security label (21) are formed integrally from the mold (10), and the manufacturer can design the label generating area (13) to generate a designated security label (21) on the plastic product (20), thereby achieving the anti-counterfeiting effect.

In one embodiment, one of the die sets (11) comprises one molding cavity (12) on the inner surface thereof, and the other die set (11) has a die block (14) located at a position corresponding to the molding cavity (12).

In another embodiment, each of the two die sets (11) has one molding cavity (12) formed on the inner surface thereof.

In still another embodiment, with minor different depths of engraving, each of the nicks (131) comprises a plurality bottom blocks (132) formed therein, such that after manufactured from the mold (10), the plastic product (20) is integrally formed with a laser security label (211), and a surface of the laser security label (211) has a plurality of uneven reflecting surfaces (2111) which enable the laser security label (211) to generate reflecting effect when viewed from an angle (referring to FIGS. 1 to 7).

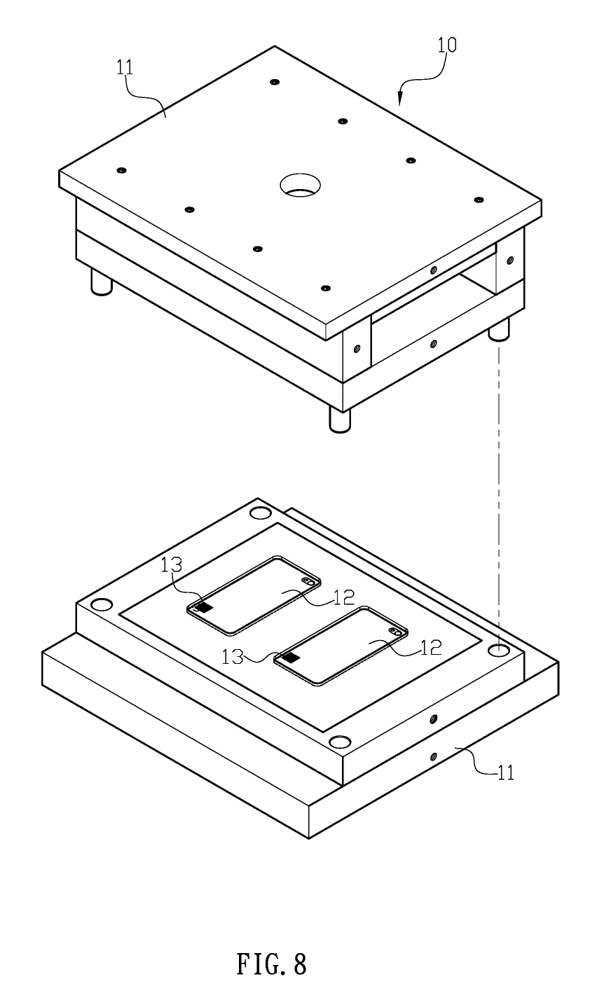

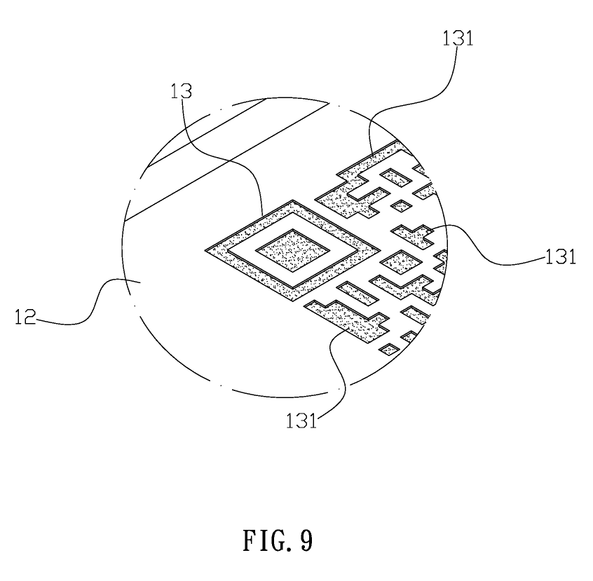

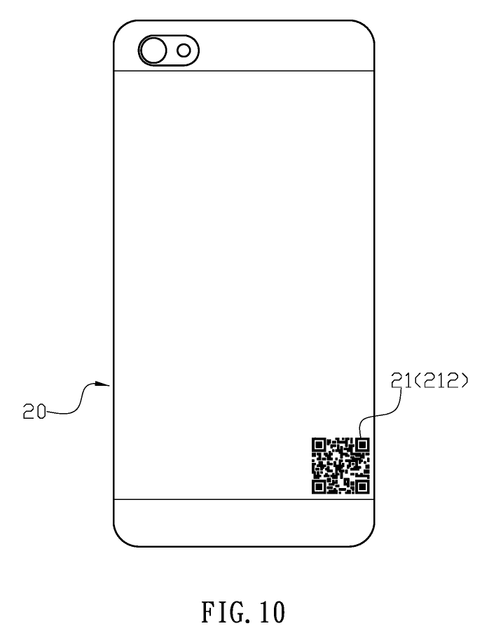

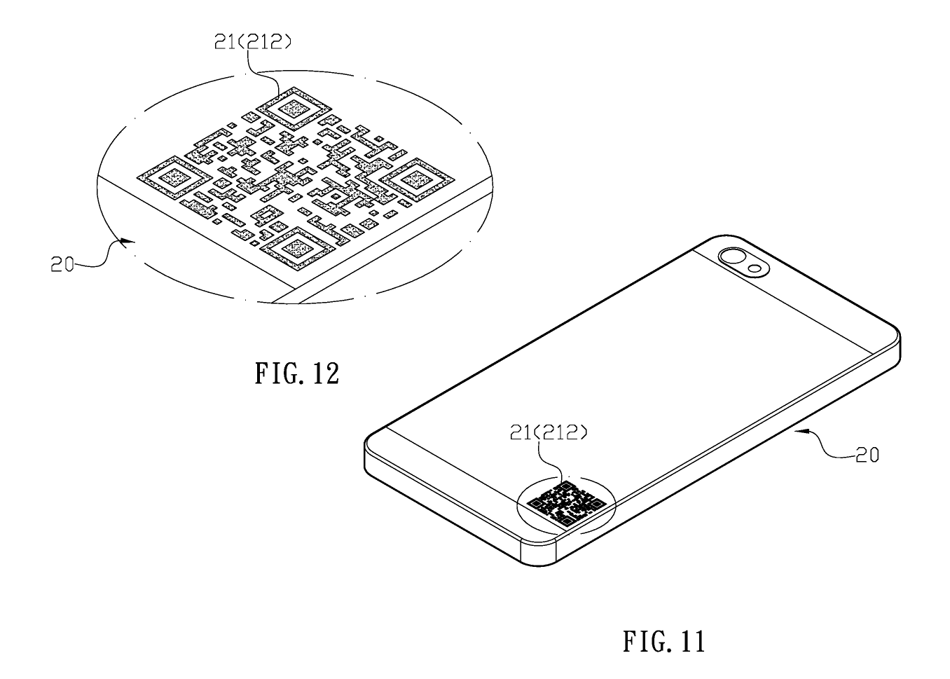

In a further embodiment, the nicks (131) are arranged to form a QR code, such that a QR code security label (212) is integrally formed on the surface of the plastic product (20) after manufacturing (referring to FIGS. 8 to 12).

In still a further embodiment, the QR code formed by the nicks (131) on the label generating area (13) is a mirror image of the manufactured QR code security label (212).

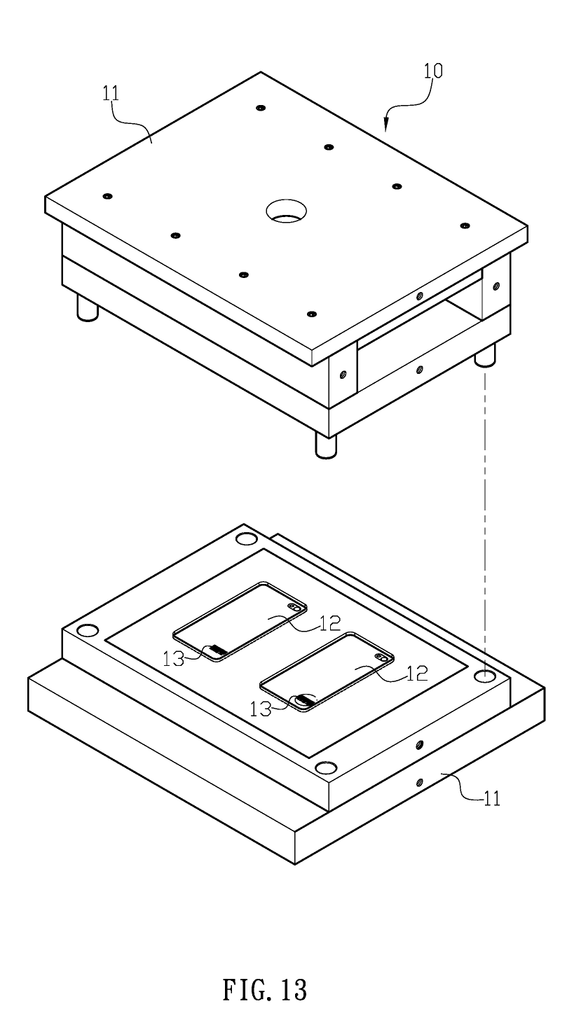

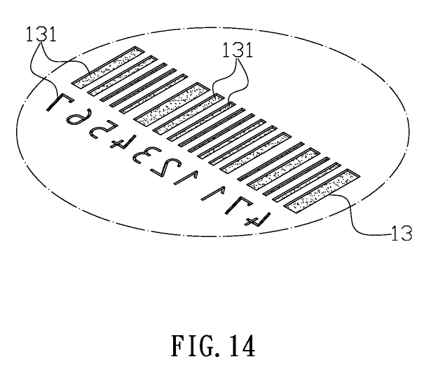

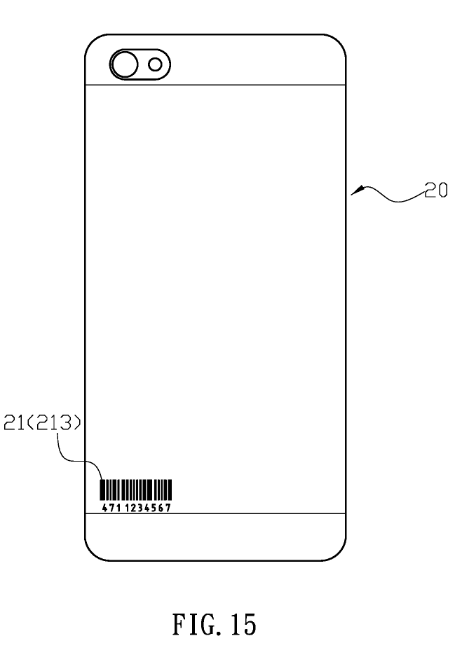

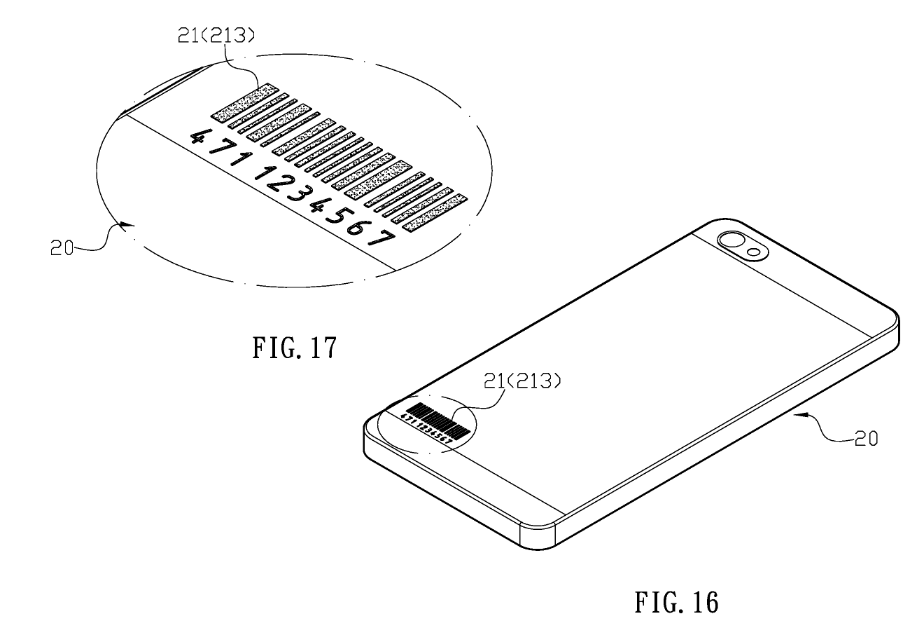

In yet a further embodiment, the nicks (131) are arranged to form a barcode, such that a barcode security label (213) is integrally formed on the surface of the plastic product (20) after manufacturing (referring to FIGS. 13 to 17).

In a particular embodiment, the nicks (131) are arranged to form a series of numbers on the label generating area (13), and the series of numbers together with the barcode security label (213) are formed on the surface of the plastic product (20) after manufacturing.

In still a particular embodiment, the barcode formed by the nicks (131) on the label generating area (13) is a mirror image of the manufactured barcode security label (213).

In a preferred embodiment, the plastic product (20) is a case for a commodity.

In still a preferred embodiment, the plastic product (20) is a packing box for a commodity.

In an advantageous embodiment, the plastic product (20) is a product tag for a commodity.

In another advantageous embodiment, the plastic product (20) is an inner part or inner component of a commodity.

Comparing with conventional anti-counterfeiting label, the present invention can provide better anti-counterfeiting effect because: (i) the security label (21) is integrally formed with the plastic product (20), which not only prevents the security label (21) from been torn by intentional person but also saves costs and labors; and (ii) the plastic product (20) can be an inner part or component of a commodity, which provides a comprehensive anti-counterfeit effect.

Having described the invention by the description and illustrations above, it should be understood that these are exemplary of the invention and are not to be considered as limiting. Accordingly, the invention is not to be considered as limited by the foregoing description, but includes any equivalents.

1. A plastic injection security label and manufacturing method of the same comprising:
a mold having a pair of die sets, and at least one of the two die sets comprising a molding cavity formed on an inner surface thereof; the inner surface of the molding cavity having a plurality of nicks formed by the laser engraving machine at partial positions thereof, such that the nicks located at positions lower than the inner surface of the molding cavity; the engraved nicks arranged into a designed image or code to form a label generating area on the inner surface of the molding cavity; the plastic material configured to be injected into the mold and filled with the molding cavity and the nicks of the label generating area after the die sets coupled together, and a plastic product with the security label integrally formed after the plastic material cooled and solidified, thereby achieving the anti-counterfeiting effect.

2. The plastic injection security label and manufacturing method of the same of claim 1, wherein one of the die sets comprises the molding cavity on the inner surface thereof, and the other die set has a die block located at a position corresponding to the molding cavity.

3. The plastic injection security label and manufacturing method of the same of claim 1, wherein each of the two die sets has the molding cavity formed on the inner surface thereof.

4. The plastic injection security label and manufacturing method of the same of claim 1, wherein with minor different depths of engraving by the laser engraving machine, a plurality bottom blocks are respectively formed inside the nicks, such that after manufactured from the mold, the plastic product is integrally formed with a laser security label, and a surface of the laser security label has a plurality of uneven reflecting surfaces which enable the laser security label to generate reflecting effect when viewed from an angle.

5. The plastic injection security label and manufacturing method of the same of claim 1, wherein the nicks are arranged to form a QR code, such that a QR code security label is integrally formed on the surface of the plastic product after manufacturing.

6. The plastic injection security label and manufacturing method of the same of claim 5, wherein the QR code formed by the nicks on the label generating area is a mirror image of the manufactured QR code security label.

7. The plastic injection security label and manufacturing method of the same of claim 1, wherein the nicks are arranged to form a barcode, such that a barcode security label is integrally formed on the surface of the plastic product after manufacturing.

8. The plastic injection security label and manufacturing method of the same of claim 7, wherein the barcode formed by the nicks on the label generating area is a mirror image of the manufactured barcode security label.

9. The plastic injection security label and manufacturing method of the same of claim 1, wherein the plastic product is a case for a commodity.

10. The plastic injection security label and manufacturing method of the same of claim 1, wherein the plastic product is a packing box for a commodity.

11. The plastic injection security label and manufacturing method of the same of claim 1, wherein the plastic product is a product tag for a commodity.

12. The plastic injection security label and manufacturing method of the same of claim 1, wherein the plastic product is an inner part or inner component of a commodity.
